(19) United States
(12) Patent Application Publication
(10) Pub. No.: US 2026/0179146 A1
(43) Pub. Date: Jun. 25, 2026

(54) LIGHTWEIGHT HIGH-DIMENSIONAL MULTIVARIATE FINANCIAL TIME SERIES DATA JOINT PREDICTION SYSTEM AND METHOD THEREOF

(71) Applicant: Wenzhou-Kean University, Wenzhou (CN)

(72) Inventors: Yan YAN, Wenzhou (CN); Ruilang LI, Wenzhou (CN); Lijie YU, Wenzhou (CN)

(21) Appl. No.: 19/024,811

(22) Filed: Jan. 16, 2025

(30) Foreign Application Priority Data
Dec. 23, 2024 (CN) 2024119097835

(51) Int. Cl. G06Q 40/06; G06N 20/00

(52) U.S. Cl. CPC G06Q 40/06; G06N 20/00

(57) ABSTRACT

The present application provides a lightweight high-dimensional multivariate financial time series data joint prediction system and method thereof, relating to the technical field of time series data analysis, and solving the problems of complex neural network framework in the existing neural network, such as non-interpretability, complexity and large computational power consumption, including a data acquisition module, a data cleaning module, a model training module, a data prediction module and a prediction visualization unit. The method includes step 1, obtaining, by a data acquisition module, time series data from different financial sources. Compared with the traditional LDS model, the aLDS adopted by the present application has a novel parameter averaging process, and in the expectation maximization algorithm, the parameters obtained by training each financial time data are averaged, so as to achieve the purpose of training multiple financial time data together.

### CROSS-REFERENCE TO RELATED APPLICATIONS

This application claims priority to Chinese Patent Application No. 202411909783.5, titled “LIGHTWEIGHT HIGH-DIMENSIONAL MULTIVARIATE FINANCIAL TIME SERIES DATA JOINT PREDICTION SYSTEM AND METHOD THEREOF”, filed on Dec. 23, 2024, the entire disclosure of which is incorporated herein by reference.

### TECHNICAL FIELD

The present application relates to the technical field of time series data analysis, and in particular to a lightweight high-dimensional multivariate financial time series data joint prediction system and method thereof.

### REARGROUND

In the financial field, the analysis and prediction of time series data are widely used in stock market, bond market, derivatives and other fields. The existing technologies include ARIMA, deep learning algorithm and so on, which have certain application scenarios in the processing and prediction of time series data. Most financial time series forecasting methods rely on historical data to capture market trends, optimize the parameters and hyperparameters of probabilistic mathematical models, and thus obtain the optimal probabilistic model to predict future data and achieve high test accuracy. In order to improve the prediction accuracy, the existing technology usually needs powerful computing power and complex algorithm models, such as the complex neural network architecture in neural networks, such as RNN, LSTM and so on.

However, the complex neural network architecture in the existing neural networks usually has some shortcomings, such as non-interpretability, over-complexity, and high computational power consumption.

Traditional financial time series forecasting algorithms, such as ARMA and ARIMA, are only suitable for simple multivariate data forecasting and cannot handle complex multi-source and high-dimensional time series data. Especially, it has obvious limitations when processing multiple high-dimensional time series data with different duration.

Deep learning algorithms are often not interpretable, such as LSTM and RNN, which have very complex network structures and are often called black-box algorithm. This is very unfriendly to users, who can't intuitively understand the actual meaning of these deep learning algorithms, and just regard the deep learning algorithm as a trained input-output function.

Deep learning algorithms often need high computing resources, such as GPUs, to train the model and find the optimal parameters, which makes deep learning algorithms unsuitable for lightweight data applications, so it is difficult for deep learning algorithms to become real-time financial time series forecasting means.

The above algorithms can only deal with a single high-dimensional time series, and they can't deal with high-dimensional multivariate time series data with different lengths, so they can't meet the existing needs. For this, we propose a lightweight high-dimensional multivariate financial time series data joint forecasting system and method thereof.

### SUMMARY

The purpose of the present application is to provide a lightweight high-dimensional multivariate financial time series data joint prediction system and method thereof, so as to solve the problems that the complex neural network architecture in the existing neural network mentioned in the background part is unexplained, too complex and consumes a lot of computing power.

To achieve the above purpose, the present application adopts the following technical solutions.

The present application provides a lightweight high-dimensional multivariate financial time series data joint prediction system, including a data acquisition module, a data cleaning module, a model training module, a data prediction module and a prediction visualization unit.

A lightweight high-dimensional multivariate financial time series data joint prediction method, including:
step 1: obtaining, by a data acquisition module, time series data from different financial sources;
step 2: preprocessing, by a data cleaning module, the obtained time series data and removing noise and abnormal values to obtain a training data set;
step 3: training, by a model training module, financial time series;
step 4: predicting, by a data prediction module, future time series data; and
step 5: showing, by a prediction visualization unit, a prediction result through a graphical interface to facilitate analysis and decision-making.

The present application is further set as follows, the training the financial time series includes training cleaned data by using an aLDS algorithm and processing the time series with different lengths by using a multivariate weighted average method.

The present technical scheme is further set as follows, the aLDS algorithm comprises an average linear dynamic system algorithm to predict the high-dimensional multivariate financial time series data, and a parameter averaging process and formula are as follows:

$${C}^{n e w} = ( {\sum }_{n = 1}^{N} {\sum }_{i = 1}^{{T}_{n}} {y}_{i}^{n} {E ( {x}_{i}^{n} )}^{T} ) {( {\sum }_{n = 1}^{N} {\sum }_{i = 1}^{{T}_{n}} E ( {{x}_{i}^{n} ( {x}_{i}^{n} )}^{T} ) )}^{- 1} ;$$

$${Σ}^{n e w} = \frac{1}{{Σ}_{n = 1}^{N} {T}_{n}} ( \begin{matrix}{\sum }_{n = 1}^{N} {\sum }_{i = 1}^{{T}_{n}} ( {{y}_{i}^{n} ( {y}_{i}^{n} )}^{T} - {C}^{n e w} E ( {x}_{i}^{n} ) {( {y}_{i}^{n} )}^{T} - {y}_{i}^{n} {E ( {x}_{i}^{n} )}^{T} {C}^{n e w} + \\ {C}^{n e w} E ( {{x}_{i}^{n} ( {x}_{i}^{n} )}^{T} ) {C}^{n e w} )\end{matrix} ) ;$$

$${A}^{n e w} = ( {\sum }_{n = 1}^{N} {\sum }_{i = 2}^{{T}_{n}} E ( {{x}_{i}^{n} ( {x}_{i - 1}^{n} )}^{T} ) ) {( {\sum }_{n = 1}^{N} {\sum }_{i = 2}^{{T}_{n}} E ( {{x}_{i - 1}^{n} ( {x}_{i - 1}^{n} )}^{T} ) )}^{- 1} ;$$

$${Γ}^{n e w} = \frac{1}{{Σ}_{n = 1}^{N} ( {T}_{n} - 1 )} ( \begin{matrix}{\sum }_{n = 1}^{N} {\sum }_{i = 2}^{{T}_{n}} ( E ( {{x}_{i}^{n} ( {x}_{i}^{n} )}^{T} - {A}^{n e w} E ( {{x}_{i - 1}^{n} ( {x}_{i}^{n} )}^{T} ) - \\ E ( {{x}_{i}^{n} ( {x}_{i - 1}^{n} )}^{T} ) {A}^{n e w} + {A}^{n e w} E ( {{x}_{i - 1}^{n} ( {x}_{i - 1}^{n} )}^{T} ) {( {A}^{n e w} )}^{T} )\end{matrix} ) ; and$$

$${μ}_{0}^{n e w} = \frac{1}{N} {\sum }_{n = 1}^{N} E ( {x}_{1}^{n} ) ;$$

wherein xᵢ is an implicit function variable, yᵢ is an actual variable, E is an expected value, c^{new} and A^{new} are matrix parameters in the aLDS algorithm, Tₙ is the length of nth of the financial time series.

The present technical scheme is further set as follows, the aLDS algorithm has a parameter averaging process, and in an expectation maximization algorithm, averaging parameters obtained by training each time series data.

The present technical scheme is further set as follows, the training data set comprises a first training data set and a test data set, and selecting 80% of the time series from the training data set as the first training data set, and selecting remaining 20% of the time series from the training data set as the validation data set. We use 10-fold cross-validation to select model hyperparameters.

Beneficial effects of the present application:

1. The aLDS algorithm of this application is a mathematical model that can accurately predict high-dimensional multivariate financial time series data, especially for the case that the data set contains a plurality of different high-dimensional multivariate time series with different lengths.

2. The aLDS algorithm of this application is a high-dimensional multivariate financial time series prediction model which is fast and efficient and uses as few computing resources as possible. Compared with the deep learning algorithm, this algorithm consumes fewer computing resources, and is especially suitable for the environment with limited computing power.

3. The aLDS algorithm of this application is a multi-source and high-dimensional multivariate time series prediction algorithm with certain physical explanation under the assumption of a reasonable data model. Compared with the traditional LDS model, the aLDS algorithm has a novel averaging parameters (parameter averaging) process, specifically, the average summation process is used in Formula (1), for example:

$${C}^{n e w} = ( {\sum }_{n = 1}^{N} {\sum }_{i = 1}^{{T}_{n}} … ) {( {\sum }_{n = 1}^{N} {\sum }_{i = 1}^{{T}_{n}} … )}^{- 1} , \\ {Σ}^{n e w} = \frac{1}{{Σ}_{n = 1}^{N} {T}_{n}} ( {\sum }_{n = 1}^{N} {\sum }_{i = 1}^{{T}_{n}} … ) ,$$

$${A}^{n e w} = ( {\sum }_{n = 1}^{N} {\sum }_{i = 2}^{{T}_{n}} … ) {( {\sum }_{n = 1}^{N} {\sum }_{i = 2}^{{T}_{n}} … )}^{- 1} ,$$

$${Γ}^{n e w} = \frac{1}{{\sum }_{n = 1}^{N} ( {T}_{n} - 1 )} ( {\sum }_{n = 1}^{N} {\sum }_{i = 2}^{{T}_{n}} … ) ,$$

wherein

$$\frac{{Σ}_{i} {a}_{i}}{n}$$

is an average process, the C^{new}, Σ^{new}, A^{new}, Γ^{new} can be equivalent to

$$\frac{{Σ}_{i} {a}_{i}}{n}$$

form.

In EM (Expectation Maximization) algorithm, the parameters obtained by training each financial time data are averaged, so as to achieve the purpose of training multiple financial time data together and further improve the prediction accuracy of the prediction model on multiple financial time data.

### BRIEF DESCRIPTION OF THE DRAWINGS

FIG. 1 is a schematic diagram of an aLDS algorithm flow according to the present application, lightweight high-dimensional multivariate financial time series data joint prediction system and method thereof.

FIG. 2 is a schematic diagram of an aLDS algorithm according to the present application, high-dimensional multivariate financial time series data joint prediction system, the forward propagation graph of parameter in each time series, wherein x represents the implicit function layer in aLDS model and y represents the actual data layer in aLDS model.

FIG. 3 is a schematic diagram of an aLDS algorithm according to the present application, high-dimensional multivariate financial time series data joint prediction system, the back propagation graph of parameter in each time series.

### DETAILED DESCRIPTION OF THE EMBODIMENTS

In order to enable those in the technical field better understand the solutions of the present application, the technical solutions in the embodiment of the present application will be described clearly and completely with the attached drawings. Obviously, the described embodiment is only a part of the embodiment of the present application, but not the whole embodiment.

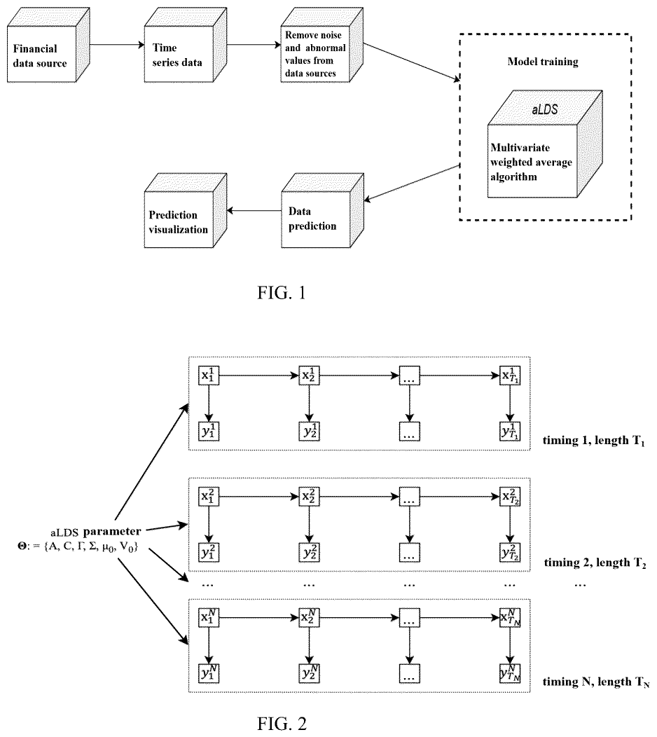

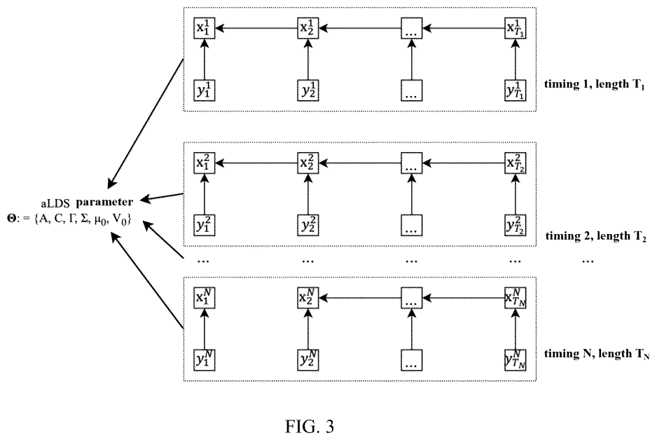

Referring to FIGS. 1 to 3, an embodiment provided by the present application is as follows, a lightweight high-dimensional multivariate financial time series data joint prediction system, including a data acquisition module, a data cleaning module, a model training module, a data prediction module and a prediction visualization unit.

A lightweight high-dimensional multivariate financial time series data joint prediction method, including:
step 1: obtaining, by a data acquisition module, time series data from different financial sources;
step 2: preprocessing, by a data cleaning module, the obtained time series data and removing noise and abnormal values to obtain a training data set; the training data set includes a first training data set and a test data set, and selecting 80% of the time series from the training data set as the first training data set, and selecting remaining 20% of the time series from the training data set as the cross-validation data set.
step 3: training, by a model training module, financial time series;
step 4: predicting, by a data prediction module, future time series data; and
step 5: showing, by a prediction visualization unit, a prediction result through a graphical interface to facilitate analysis and decision-making.

Wherein the training the financial time series includes training cleaned data by using an aLDS algorithm and processing the time series with different lengths by using a multivariate weighted average method. The aLDS algorithm comprises an average linear dynamic system algorithm to predict the multi-source and high-dimensional multivariate financial time series data, and a parameter averaging process and formula are as follows:

$${C}^{n e w} = ( {\sum }_{n = 1}^{N} {\sum }_{i = 1}^{{T}_{n}} {y}_{i}^{n} {E ( {x}_{i}^{n} )}^{T} ) {( {\sum }_{n = 1}^{N} {\sum }_{i = 1}^{{T}_{n}} E ( {{x}_{i}^{n} ( {x}_{i}^{n} )}^{T} ) )}^{- 1} ;$$

$${Σ}^{n e w} = \frac{1}{{Σ}_{n = 1}^{N} {T}_{n}} ( \begin{matrix}{\sum }_{n = 1}^{N} {\sum }_{i = 1}^{{T}_{n}} ( {{y}_{i}^{n} ( {y}_{i}^{n} )}^{T} - {C}^{n e w} E ( {x}_{i}^{n} ) {( {y}_{i}^{n} )}^{T} - {y}_{i}^{n} {E ( {x}_{i}^{n} )}^{T} {C}^{n e w} + \\ {C}^{n e w} E ( {{x}_{i}^{n} ( {x}_{i}^{n} )}^{T} ) {C}^{n e w} )\end{matrix} ) ;$$

$${A}^{n e w} = ( {\sum }_{n = 1}^{N} {\sum }_{i = 2}^{{T}_{n}} E ( {{x}_{i}^{n} ( {x}_{i - 1}^{n} )}^{T} ) ) {( {\sum }_{n = 1}^{N} {\sum }_{i = 2}^{{T}_{n}} E ( {{x}_{i - 1}^{n} ( {x}_{i - 1}^{n} )}^{T} ) )}^{- 1} ;$$

$${Γ}^{n e w} = \frac{1}{{Σ}_{n = 1}^{N} ( {T}_{n} - 1 )} ( \begin{matrix}{\sum }_{n = 1}^{N} {\sum }_{i = 2}^{{T}_{n}} ( E ( {{x}_{i}^{n} ( {x}_{i}^{n} )}^{T} - {A}^{n e w} E ( {{x}_{i - 1}^{n} ( {x}_{i}^{n} )}^{T} ) - \\ E ( {{x}_{i}^{n} ( {x}_{i - 1}^{n} )}^{T} ) {A}^{n e w} + {A}^{n e w} E ( {{x}_{i - 1}^{n} ( {x}_{i - 1}^{n} )}^{T} ) {( {A}^{n e w} )}^{T} )\end{matrix} ) ; and$$

$${μ}_{0}^{n e w} = \frac{1}{N} {\sum }_{n = 1}^{N} E ( {x}_{1}^{n} ) ;$$

wherein xᵢ is an implicit function variable, yᵢ is an actual variable, E is an expected value, C^{new} and A^{new} are matrix parameters in the aLDS algorithm, Tₙ is the length of nth of the financial time series.

The aLDS algorithm has a parameter averaging process, and in an expectation maximization algorithm, averaging parameters obtained by training each time series data.

Weighted average method of multivariate financial time series based on aLDS algorithm: compared with the traditional LDS model, the aLDS algorithm has a novel averaging parameters (parameter averaging) process, specifically, the average summation process is used in Formula (1), for example:

$${C}^{n e w} = ( {\sum }_{n = 1}^{N} {\sum }_{i = 1}^{{T}_{n}} … ) {( {\sum }_{n = 1}^{N} {\sum }_{i = 1}^{{T}_{n}} … )}^{- 1} , \\ {Σ}^{n e w} = \frac{1}{{Σ}_{n = 1}^{N} {T}_{n}} ( {\sum }_{n = 1}^{N} {\sum }_{i = 1}^{{T}_{n}} … ) ,$$

$${A}^{n e w} = ( {\sum }_{n = 1}^{N} {\sum }_{i = 2}^{{T}_{n}} … ) {( {\sum }_{n = 1}^{N} {\sum }_{i = 2}^{{T}_{n}} … )}^{- 1} ,$$

$${Γ}^{n e w} = \frac{1}{{\sum }_{n = 1}^{N} ( {T}_{n} - 1 )} ( {\sum }_{n = 1}^{N} {\sum }_{i = 2}^{{T}_{n}} … ) ,$$

wherein

$$\frac{{Σ}_{i} {a}_{i}}{n}$$

is an average process, the C^{new}, Σ^{new}, A^{new}, Γ^{new} can be equivalent to

$$\frac{{Σ}_{i} {a}_{i}}{n}$$

form.

In EM (Expectation Maximization) algorithm, the parameters obtained by training each financial time data are averaged, so as to achieve the purpose of training multiple financial time data together and further improve the prediction accuracy of the prediction model on multiple financial time data.

Training and forecasting process for multi-source and high-dimensional multivariate financial time series forecasting model: different from traditional financial time series forecasting methods such as ARIMA (auto regressive integrated moving average model) and LSTM (Long Short-Term Memory network), and RNN (Recurrent Neural Network), the segmentation of training data set and test data set is complete, that is, selecting 80% of the time series from the data as the training data set and the remaining 20% as the cross-validation data set. When our model is trained on the training data set, these model parameters and hyperparameters will be directly substituted into the test data set for further evaluation and data visualization.

It is obvious to those skilled in the art that the present application is not limited to the details of the above-mentioned exemplary embodiment, but can be realized in other specific forms without departing from the spirit or essential characteristics of the present application. The present application has been described in detail above. The above is only the preferred embodiment of the present application. If the scope of implementation of the present application cannot be limited, that is, all the equal changes and modifications made according to the scope of this application should still fall within the scope of the present application. Any reference signs in the claims shall not be construed as limiting the claims concerned.

What is claimed is:

1. A lightweight high-dimensional multivariate financial time series data joint prediction system, comprising:
a data acquisition module, a data cleaning module, a model training module, a data prediction module and a prediction visualization unit.

2. A lightweight multi-source and high-dimensional financial time series data joint prediction method, comprising:
step 1: obtaining, by a data acquisition module, time series data from different financial sources;
step 2: preprocessing, by a data cleaning module, the obtained time series data and removing noise and abnormal values to obtain a training data set;
step 3: training, by a model training module, financial time series;
step 4: predicting, by a data prediction module, future time series data; and
step 5: showing, by a prediction visualization unit, prediction result through a graphical interface to facilitate analysis and decision-making.

3. The lightweight high-dimensional multivariate financial time series data joint prediction method of claim 2, wherein the training the financial time series comprises:
training cleaned data by using an aLDS algorithm and processing the time series with different lengths by using a multivariate weighted average method.

4. The lightweight high-dimensional multivariate financial time series data joint prediction method of claim 3, wherein the aLDS algorithm comprises an average linear dynamic system algorithm to predict the multi-source and high-dimensional financial time series data, and a parameter averaging process and formula are as follows:
$${C}^{n e w} = ( {\sum }_{n = 1}^{N} {\sum }_{i = 1}^{{T}_{n}} {y}_{i}^{n} {E ( {x}_{i}^{n} )}^{T} ) {( {\sum }_{n = 1}^{N} {\sum }_{i = 1}^{{T}_{n}} E ( {{x}_{i}^{n} ( {x}_{i}^{n} )}^{T} ) )}^{- 1} ;$$
$${Σ}^{n e w} = \frac{1}{{Σ}_{n = 1}^{N} {T}_{n}} ( \begin{matrix}{\sum }_{n = 1}^{N} {\sum }_{i = 1}^{{T}_{n}} ( {{y}_{i}^{n} ( {y}_{i}^{n} )}^{T} - {C}^{n e w} E ( {x}_{i}^{n} ) {( {y}_{i}^{n} )}^{T} - {y}_{i}^{n} {E ( {x}_{i}^{n} )}^{T} {C}^{n e w} + \\ {C}^{n e w} E ( {{x}_{i}^{n} ( {x}_{i}^{n} )}^{T} ) {C}^{n e w} )\end{matrix} ) ;$$
$${A}^{n e w} = ( {\sum }_{n = 1}^{N} {\sum }_{i = 2}^{{T}_{n}} E ( {{x}_{i}^{n} ( {x}_{i - 1}^{n} )}^{T} ) ) {( {\sum }_{n = 1}^{N} {\sum }_{i = 2}^{{T}_{n}} E ( {{x}_{i - 1}^{n} ( {x}_{i - 1}^{n} )}^{T} ) )}^{- 1} ;$$
$${Γ}^{n e w} = \frac{1}{{Σ}_{n = 1}^{N} ( {T}_{n} - 1 )} ( \begin{matrix}{\sum }_{n = 1}^{N} {\sum }_{i = 2}^{{T}_{n}} ( E ( {{x}_{i}^{n} ( {x}_{i}^{n} )}^{T} - {A}^{n e w} E ( {{x}_{i - 1}^{n} ( {x}_{i}^{n} )}^{T} ) - \\ E ( {{x}_{i}^{n} ( {x}_{i - 1}^{n} )}^{T} ) {A}^{n e w} + {A}^{n e w} E ( {{x}_{i - 1}^{n} ( {x}_{i - 1}^{n} )}^{T} ) {( {A}^{n e w} )}^{T} )\end{matrix} ) ; and$$
$${μ}_{0}^{n e w} = \frac{1}{N} {\sum }_{n = 1}^{N} E ( {x}_{1}^{n} ) ;$$
wherein xᵢ is an implicit function variable, yᵢ is an actual variable, E is an expected value, C^{new} and A^{new} are matrix parameters in the aLDS algorithm, Tₙ is the length of the financial time series.

5. The lightweight high-dimensional multivariate financial time series data joint prediction method of claim 4, wherein the aLDS algorithm has a parameter averaging process, and in an expectation maximization algorithm, averaging parameters obtained by training each time series data.

6. The lightweight high-dimensional multivariate financial time series data joint prediction method of claim 2, wherein the training data set comprises a first training data set and a test data set, and selecting 80% of the time series from the training data set as the first training data set, and selecting remaining 20% of the time series from the training data set as a cross-validation data set.
